(19) United States
(12) Patent Application Publication
(10) Pub. No.: US 2026/0042431 A1
(43) Pub. Date: Feb. 12, 2026

(54) LOCKED WHEEL PROTECTION ON BATTERY BACKUP

(71) Applicant: GOODRICH CORPORATION, Charlotte, NC (US)

(72) Inventors: Marc J Georgin, Oakwood, OH (US); Kaman Thapa Magar, Beavercreek, OH (US)

(73) Assignee: GOODRICH CORPORATION, Charlotte, NC (US)

(21) Appl. No.: 18/797,239

(22) Filed: Aug. 7, 2024

(51) Int. Cl. B60T 8/32; B60T 8/17

(52) U.S. Cl. CPC B60T 8/325; B60T 8/1703; B60T 2270/414

(57) ABSTRACT

A method is provided for controlling brake assemblies of a vehicle. The method includes, responsive to identifying that only battery backup power is available in the vehicle, modifying, by a brake control unit (BCU), one or more parameters of a set of parameters for locked wheel protection for a set of wheels on the vehicle to adjust for utilizing the battery backup power. The method further includes, responsive to detecting a locked wheel event, applying, by the BCU, the locked wheel protection to a brake assembly of a wheel of the vehicle utilizing the modified one or more parameters of the set of parameters.

### FIELD

The present disclosure generally relates to the field of aircraft and, more particularly, to control of aircraft braking systems using locked wheel protection on battery backup.

### BACKGROUND

Locked wheel protection (LWP) is an important part of hydroplaning control for aircraft brake control system. Locked wheel protection compares the wheel speed of two or more wheels and, if one of the wheels is too slow, locked wheel protection releases the brake pressure on the slow wheel.

### SUMMARY

According to various embodiments of the present disclosure, a method for controlling brake assemblies of a vehicle is provided. The method includes, responsive to identifying that only battery backup power is available in the vehicle, modifying, by a brake control unit (BCU), one or more parameters of a set of parameters for locked wheel protection for a set of wheels on the vehicle to adjust for utilizing the battery backup power and, responsive to detecting a locked wheel event, applying, by the BCU, the locked wheel protection to a brake assembly of a wheel of the vehicle utilizing the modified one or more parameters of the set of parameters.

In various embodiments, the set of parameters includes increasing a gear speed threshold, decrease a time to confirm the locked wheel event, and decreasing a threshold to re-apply braking.

In various embodiments, the gear speed threshold is increased to between 50% and 80%.

In various embodiments, the time to confirm the locked wheel event is decreased to between 50 ms and 150 ms.

In various embodiments, the threshold to re-apply braking is decreased to between 60% and 40%.

In various embodiments, the method further includes disabling, by the BCU, an antiskid feature for the vehicle.

In various embodiments, identifying that only the battery backup power is available in the vehicle is performed in response to the BCU receiving a brake command.

In various embodiments, the locked wheel event is indicated by a wheel speed transducer indicating the wheel is rotating less than a percentage of a gear speed for about a predetermined time period.

Also disclosed herein is a braking system for controlling brake assemblies of a vehicle. The braking system includes a brake control unit. The brake control unit is configured to, responsive to identifying that only battery backup power is available in the vehicle, modify one or more parameters of a set of parameters for locked wheel protection for a set of wheels on the vehicle to adjust for utilizing the battery backup power and, responsive to detecting a locked wheel event, apply the locked wheel protection to a brake assembly of a wheel in the set of wheels on the vehicle utilizing the modified one or more parameters of the set of parameters.

In various embodiments, the set of parameters includes increasing a gear speed threshold, decrease a time to confirm the locked wheel event, and decreasing a threshold to re-apply braking.

In various embodiments, the gear speed threshold is increased to between 50% and 80%.

In various embodiments, the time to confirm the locked wheel event is decreased to between 50 ms and 150 ms.

In various embodiments, the threshold to re-apply braking is decreased to between 60% and 40%.

In various embodiments, the brake control unit is further configured to disable an antiskid feature for the vehicle.

Also disclosed herein is an aircraft. The aircraft includes a wheel, a brake assembly associated with the wheel, and a brake control unit. The brake control unit is configured to, responsive to identifying that only battery backup power is available in the aircraft, modify one or more parameters of a set of parameters for locked wheel protection for a set of wheels on the aircraft to adjust for utilizing the battery backup power and, responsive to detecting a locked wheel event, apply the locked wheel protection to the brake assembly associated with the wheel on the aircraft utilizing the modified one or more parameters of the set of parameters.

In various embodiments, the set of parameters includes increasing a gear speed threshold, decrease a time to confirm the locked wheel event, and decreasing a threshold to re-apply braking.

In various embodiments, the gear speed threshold is increased to between 50% and 80%.

In various embodiments, the time to confirm the locked wheel event is decreased to between 50 ms and 150 ms.

In various embodiments, the threshold to re-apply braking is decreased to between 60% and 40%.

In various embodiments, the brake control unit is further configured to disable an antiskid feature for the aircraft.

The present disclosure may include any one or more of the individual features disclosed above and/or below alone or in any combination thereof.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an aircraft, in accordance with various embodiments.

FIG. 2 illustrates an aircraft including multiple landing gear systems, in accordance with various embodiments.

FIG. 3 illustrates an E-brake system that receives high power high voltage (HPHV) (260 VDC), high power low voltage (HPLV) battery backup (28 VDC), and low power low voltage (LPLV) (28 VDC) from an aircraft power system, in accordance with various embodiments.

FIGS. 4A and 4B illustrate an E-brake system retracting the EBAs from the brake stack responsive to HPHV (260 VDC) powering the EBAC and responsive to HPLV battery backup (28 VDC) powering the EBAC, respectively, in accordance with various embodiments.

FIG. 5 illustrates a method for aircraft brake control is illustrated, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

Electric brake (E-brake) systems are typically provided with 260 Volts Direct Current (VDC) power under normal operating conditions for electric brake actuator (EBA) actuation. The 260 VDC allows full performance of the system for braking and antiskid and locked wheel (LW) protection. E-brake systems are often provided with backup power for braking capability when the 260 VDC is lost. Typically, the aircraft power system will only provide 28 VDC through batteries. A typical requirement for antiskid frequency response with an application of 50% force+/−10% is at least 10˜12 Hertz (Hz). When using only the 28 VDC battery backup power, a typical requirement for antiskid frequency response with an application of 50% force+/−5% is at least 10 Hz. However, this performance requirement assumes that 260 VDC is still provided (usually through a step-up circuitry from 28 VDC to 260 VDC). If only using a 28 VDC supply without the step-up circuitry and receiving a command to provide 50% force+/−5% at 10 Hz, the E-brake system is not capable of following the command because, responsive to using only 28 VDC battery backup power, the E-brake system is not able to operate antiskid functionality to protect the tires during braking because the frequency response is too slow, i.e. only 3˜4 Hz. Accordingly, a viable way is needed for an E-brake system that only has access to 28 VDC battery backup power, responsive to normal 260 VDC being lost, to still provide tire protection during braking using an adaptive locked wheel protection functionality. Locked wheel protection (LWP) is an important part of hydroplaning control for brake control system on a vehicle, such as an automobile or aircraft, among others. On an aircraft, the LWP function activates in response to the identification of bad runway conditions that benefit from an immediate release of brake pressure (hydraulic systems) or brake clamping force (electrical systems). For example, hydroplaning of a wheel may occur due to water on a runway or a runway surface with compromised integrity. In various embodiments, a LWP event is indicated by a wheel speed transducer indicating a wheel speed of zero or substantially zero or indicating that the wheel is rotating at less than 30% of a gear speed for about 200 milliseconds (ms), where about in this context only means+/−10 ms.

Therefore, disclosed herein are methods and systems for controlling an aircraft E-brake system using only 28 VDC battery backup. In various embodiments, the EBA controller (EBAC) receives high power high voltage (HPHV) (260 VDC), high power low voltage (HPLV) battery backup (28 VDC), and low power low voltage (LPLV) (28 VDC). In various embodiments, the HPHV (260 VDC) and HPLV battery backup (28 VDC) are both provided, through an electrical coupling, to the EBAC to control the EBAs; however, only one of the HPHV (260 VDC) and HPLV battery backup (28 VDC) is active at any one time. In various embodiments, the HPHV (260 VDC) and HPLV battery backup (28 VDC) are each electrically coupled to the EBAC through diodes to avoid reinjecting voltage in the other circuit. In various embodiments, a converter, i.e. the step-up circuitry is not needed, because, in response to the HPHV (260 VDC) being lost, the EBAC is provided with HPLV battery backup (28 VDC) to control the EBAs. As discussed previously, when using only HPLV battery backup (28 VDC), the E-brake system is not able to operate antiskid functionality to protect the tires during braking because the frequency response is too slow, i.e. only 3˜4 Hz. In that regard, the antiskid functionality is disabled, and an adaptive locked wheel protection functionality is provided.

Typically, LWP operates such that, responsive to the brake control unit (BCU) detecting that a wheel is rotating at less than 30% of a gear speed for about 200 ms, the BCU commands an immediate release of the brake to allow the wheel to spin up. Responsive to the wheel spinning up to about 70% of the gear speed, the BCU commands a termination of the LWP and commands a reapplication of braking. In various embodiments, responsive to the BCU detecting that the HPHV (260 VDC) and the EBAC only having HPLV battery backup (28 VDC) to actuate the EBAs, the BCU may increase the 30% gear speed threshold such that the BCU starts timing a skid event earlier. In various embodiments, the BCU may increase the gear speed threshold to between 50% and 80%. In various embodiments, the BCU may increase the gear speed threshold to between 60% and 75%. In various embodiments, the BCU may increase the gear speed threshold to 70%. In various embodiments, the BCU may further decrease the time to confirm a locked wheel event from the 200 ms. In various embodiments, the BCU may decrease the time to confirm the locked wheel event to between 50 ms and 150 ms. In various embodiments, the BCU may decrease the time to confirm the locked wheel event to between 70 ms and 100 ms. In various embodiments, the BCU may decrease the time to confirm the locked wheel event to 75 ms. In various embodiments, by the BCU decreasing the time to confirm the locked wheel event provides for decreasing the force applied by the EBA to the brake stack sooner, since the force applied by the EBA decreases at a slower rate due to the HPLV battery backup (28 VDC). In various embodiments, the BCU may also decrease the 70% threshold to re-apply braking. In various embodiments, the BCU may decrease the threshold to re-apply braking to between 60% and 40%. In various embodiments, the BCU may decrease the threshold to re-apply braking to between 55% and 45%. In various embodiments, the BCU may decrease the threshold to re-apply braking to 50%. In various embodiments, since the rate of reapplication of the brake is slower due to the HPLV battery backup (28 VDC), it is therefore possible for the BCU to reapply braking earlier while the wheel is spinning up. In various embodiments, by modifying the parameters associated with the LWP, locking up of the wheels during braking may be reduced or prevented.

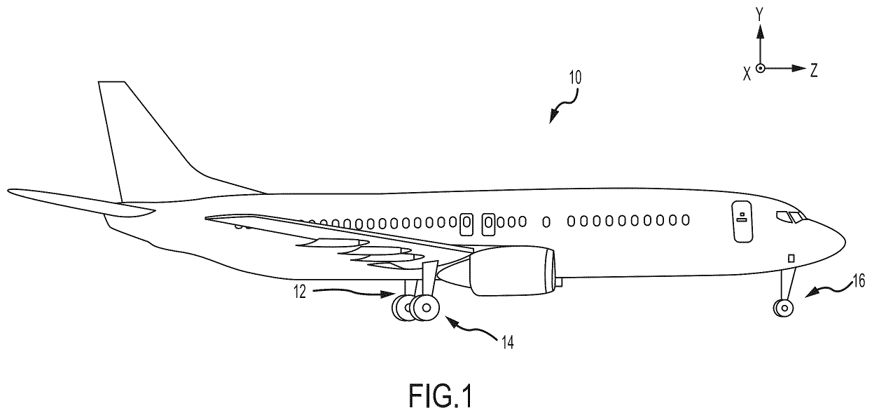

Referring now to FIG. 1, in accordance with various embodiments, an aircraft 10 is illustrated. The aircraft 10 includes landing gear, which may include a left main landing gear 12, a right main landing gear 14 and a nose landing gear 16. The landing gear support the aircraft 10 when it is not flying, allowing the aircraft 10 to taxi, take off and land without damage. While the disclosure refers to the three landing gear configurations just referred, the disclosure nevertheless contemplates any number of landing gear configurations.

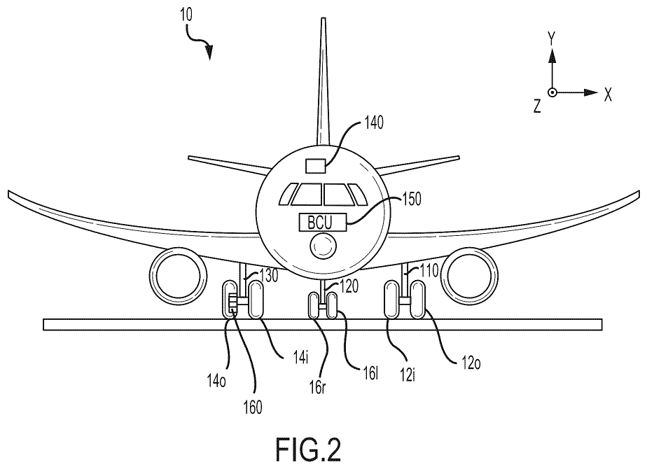

Turning now to FIG. 2, in accordance with various embodiments, an aircraft 100 includes multiple landing gear systems, including a first landing gear 110, second landing gear 120, and third landing gear 130 is illustrated. The first landing gear 110, second landing gear 120, and third landing gear 130 each include one or more wheel assemblies. In various embodiments, the second landing gear 120, which is also a nose landing gear for the aircraft 100, includes a left wheel assembly 161 and a right wheel assembly 16r. In various embodiments, the first landing gear 110 includes an inboard wheel assembly 12i and an outer wheel assembly 120, and the third landing gear 130 includes an inner wheel assembly 14i and an outer wheel assembly 140. The first landing gear 110, second landing gear 120, and third landing gear 130 support the aircraft 100 when the aircraft 100 is not flying, thereby allowing the aircraft 100 to take off, land, and taxi without damaging the aircraft 100. In various embodiments, the second landing gear 120 is also a nose landing gear for the aircraft 100, and often times, one or more of the first landing gear 110, second landing gear 120, and third landing gear 130 are operationally retractable into the aircraft 100 when the aircraft 100 is in flight and/or airborne.

In various embodiments, the aircraft 100 further includes an avionics unit 140, which includes one or more controllers (e.g., processors) and one or more tangible, non-transitory memories capable of implementing digital or programmatic logic. In various embodiments, for example, the one or more controllers are one or more of a general-purpose processor, digital signal processor (DSP), application specific integrated circuit (ASIC), field programmable gate array (FPGA), or other programmable logic device, discrete gate, transistor logic, or discrete hardware components, or any various combinations thereof or the like. In various embodiments, the avionics unit 140 controls, at least various parts of, the flight of, and operation of various components of, the aircraft 100. For example, the avionics unit 140 controls various parameters of flight, such as an air traffic management systems, auto-pilot systems, auto-thrust systems, crew alerting systems, electrical systems, electronic checklist systems, electronic flight bag systems, engine systems flight control systems, environmental systems, hydraulics systems, lighting systems, pneumatics systems, traffic avoidance systems, trim systems, and the like.

In various embodiments, the aircraft 100 further includes a brake control unit (BCU) 150. The BCU 150 includes one or more controllers (e.g., processors) and one or more tangible, non-transitory memories capable of implementing digital or programmatic logic. In various embodiments, for example, the one or more controllers are one or more of a general purpose processor, DSP, ASIC, FPGA, or other programmable logic device, discrete gate, transistor logic, or discrete hardware components, or any various combinations thereof or the like, and the one or more memories store instructions that are implemented by the one or more controllers for performing various functions, such as monitoring a health status of a servo valve, as will be discussed herein. In various embodiments, the BCU 150 controls, at least various parts of, the braking of the aircraft 100. For example, the BCU 150 controls various parameters of braking, such as manual brake control, automatic brake control, antiskid braking, locked wheel protection, touchdown protection, park capability, gear retraction braking, and the like.

In various embodiments, the aircraft 100 further includes one or more brakes coupled to each wheel assembly. For example, a brake 160 is coupled to the outer wheel assembly 140 of the third landing gear 130 of the aircraft 100. In operation, the brake 160 applies a braking force to the outer wheel assembly 140 upon receiving a brake command, such as from the BCU 150. In various embodiments, the outer wheel assembly 140 of the third landing gear 130 of the aircraft 100 includes any number of wheels.

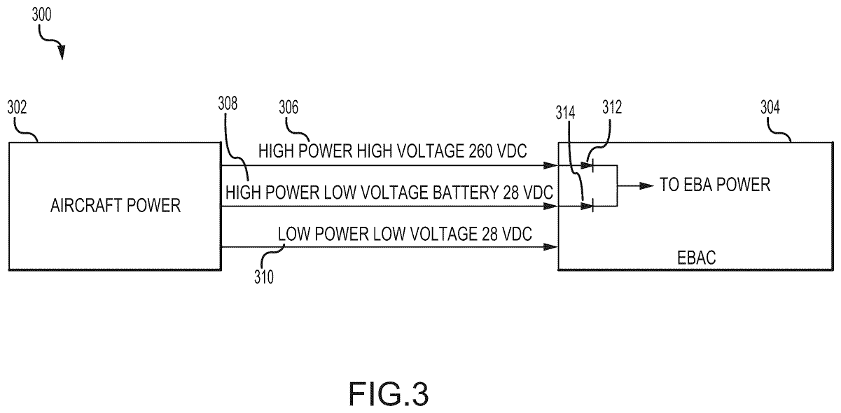

Turning now to FIG. 3, in accordance with various embodiments, an E-brake system that receives high power high voltage (HPHV) (260 VDC), high power low voltage (HPLV) battery backup (28 VDC), and low power low voltage (LPLV) (28 VDC) from an aircraft power system is illustrated. In various embodiments, low power low voltage (LPLV) (28 VDC) is backed up by battery. In various embodiments, the E-brake power system 300 includes aircraft power system 302 of an aircraft, such as aircraft 10 of FIGS. 1 and 2, and an electric brake actuator controller (EBAC) 304, which receives commands from a brake control unit (BCU), such as BCU 150 of FIG. 2, to control the electric brake actuators (EBACs) of the brake, such as brake 160 of FIG. 2. In various embodiments, the aircraft power system 302 provides HPHV (260 VDC) 306, HPLV battery backup (28 VDC) 308, and LPLV (28 VDC) 310 to the EBAC 304, via an electrical coupling, to control the EBAs associated with the brakes. In various embodiments, only one of the HPHV (260 VDC) 306 and HPLV battery backup (28 VDC) 308 is active at any one time. In various embodiments, the HPHV (260 VDC) 306 and HPLV battery backup (28 VDC) 308 are each electrically coupled to the EBAC 304 through respective diodes 312 and 314 to avoid reinjecting voltage in the other circuit.

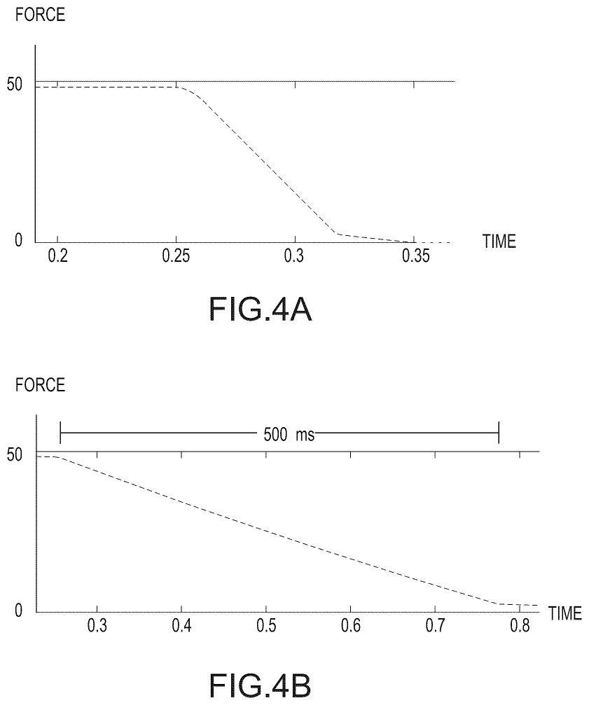

Turning now to FIGS. 4A and 4B, in accordance with various embodiments, an E-brake system retracting the EBAs from the brake stack responsive to HPHV (260 VDC) powering the EBAC and responsive to HPLV battery backup (28 VDC) powering the EBAC, respectively, is illustrated. Typically, as illustrated in FIG. 4A, under normal power conditions, responsive to the EBAC and EBAs being powered by HPHV (260 VDC), it takes approximately 70 ms to drop the force applied by the EBAs to the brake stack from 50% to 0% zero torque position (ZTP), i.e. no force applied. Typically, as illustrated in FIG. 4B, under normal power conditions, responsive to the EBAC and EBAs being powered by HPLV battery backup (28 VDC), it takes approximately 500 ms to drop the force applied by the EBAs to the brake stack from 50% to 0% zero torque position (ZTP), i.e. no force applied.

In various embodiments, responsive to the BCU detecting that the HPHV (260 VDC) and the EBAC only having HPLV battery backup (28 VDC) to actuate the EBAs, the BCU may increase the 30% gear speed threshold such that the BCU starts timing a skid event earlier than in a conventional system. In various embodiments, the BCU may increase the gear speed threshold to between 50% and 80%. In various embodiments, the BCU may increase the gear speed threshold to between 60% and 75%. In various embodiments, the BCU may increase the gear speed threshold to 70%. In various embodiments, the BCU may further decrease the time to confirm a locked wheel event from the 200 ms. In various embodiments, the BCU may decrease the time to confirm the locked wheel event to between 50 ms and 150 ms. In various embodiments, the BCU may decrease the time to confirm the locked wheel event to between 70 ms and 100 ms. In various embodiments, the BCU may decrease the time to confirm the locked wheel event to 75 ms. In various embodiments, by the BCU decreasing the time to confirm the locked wheel event provides for decreasing the force applied by the EBA to the brake stack sooner, since the force applied by the EBA decreases at a slower rate due to the HPLV battery backup (28 VDC). In various embodiments, the BCU may also decrease the 70% threshold to re-apply braking. In various embodiments, the BCU may decrease the threshold to re-apply braking to between 60% and 40%. In various embodiments, the BCU may decrease the threshold to re-apply braking to between 55% and 45%. In various embodiments, the BCU may decrease the threshold to re-apply braking to 50%. In various embodiments, since the rate of reapplication of the brake is slower due to the HPLV battery backup (28 VDC), it is therefore possible for the BCU to reapply braking earlier while the wheel is spinning up. In various embodiments, by modifying the parameters associated with the LWP, locking up of the wheels during braking may be reduced or prevented.

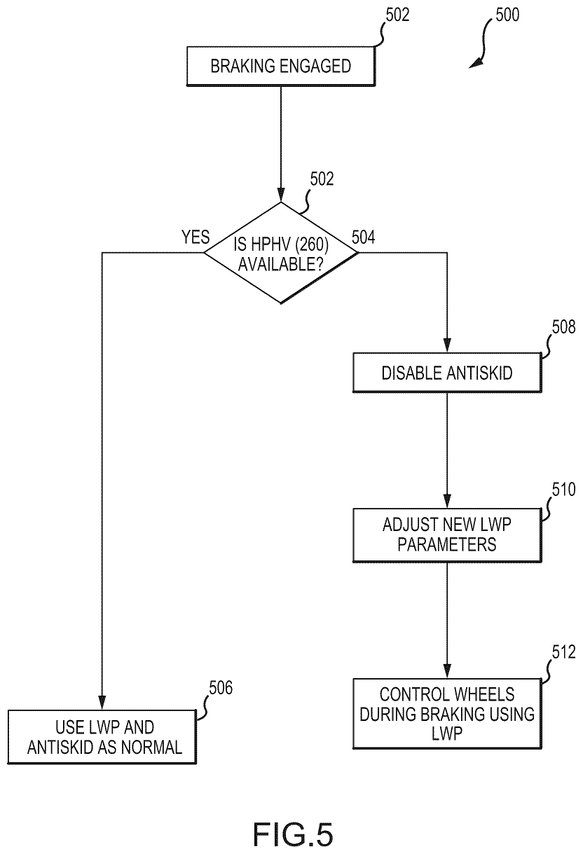

Referring now to FIG. 5, in accordance with various embodiments, a method 500 for aircraft brake control is illustrated. Method 500 may be performed by a processor within a brake control unit (BCU), such as 150 of FIG. 2. At block 502, the BCU receives a command to apply braking for a braking event. At block 504, the BCU determines whether HPHV (260 VDC) is available. If at block 504 the BCU determines that HPHV (260 VDC) is available, then, at block 506, the BCU uses the HPHV (260 VDC) and performs LWP and antiskid as normal. If at block 504 the BCU determines that only HPLV battery backup (28 VDC), then at block 508, the BCU disables antiskid because the frequency response using HPLV battery backup (28 VDC) is too slow, i.e. only 3˜4 Hz.

Once antiskid is disabled, then, at block 510, the BCU modifies one or parameters for operating the LWP. In various embodiments, at block 510, the BCU may increase the 30% gear speed threshold such that the BCU starts timing a skid event earlier. In various embodiments, the BCU may increase the gear speed threshold to between 50% and 80%. In various embodiments, the BCU may increase the gear speed threshold to between 60% and 75%. In various embodiments, the BCU may increase the gear speed threshold to 70%. In various embodiments, at block 510, the BCU may further decrease the time to confirm a locked wheel event from the 200 ms. In various embodiments, the BCU may decrease the time to confirm the locked wheel event to between 50 ms and 150 ms. In various embodiments, the BCU may decrease the time to confirm the locked wheel event to between 70 ms and 100 ms. In various embodiments, the BCU may decrease the time to confirm the locked wheel event to 75 ms. In various embodiments, by the BCU decreasing the time to confirm the locked wheel event provides for decreasing the force applied by the EBA to the brake stack sooner, since the force applied by the EBA decreases at a slower rate due to the HPLV battery backup (28 VDC). In various embodiments, the BCU may also decrease the 70% threshold to re-apply braking. In various embodiments, at block 510, the BCU may decrease the threshold to re-apply braking to between 60% and 40%. In various embodiments, the BCU may decrease the threshold to re-apply braking to between 55% and 45%. In various embodiments, the BCU may decrease the threshold to re-apply braking to 50%. In various embodiments, since the rate of reapplication of the brake is slower due to the HPLV battery backup (28 VDC), it is therefore possible for the BCU to reapply braking earlier while the wheel is accelerating. In various embodiments, by modifying the parameters associated with the LWP, locking up of the wheels during braking may be reduced or prevented. Once the BCU has changed one or more of the LWP parameters, then, at block 512, the BCU may control the wheels during the braking event using LWP and the modified parameters. Accordingly, the E-brake system, with the HPLV battery backup (28 VDC) power for the EBAs may apply the commanded force but with a slower response time. The slower response time may be deemed acceptable since the HPHV (260 VDC) is not available and normal conditions do not apply. Once the aircraft has been stopped, the aircraft may be serviced to remedy the power situation.

Accordingly, the various embodiments provide a viable way to have an E-brake system architecture that operates with only HPLV battery backup (28 VDC) power, responsive to the HPHV (260 VDC) power being lost, and still provide tire protection during braking using an adaptive locked wheel protection function. Utilizing the system of various embodiments, also provides an E-brake system that uses HPHV (260 VDC) provided by the aircraft with only HPLV battery backup (28 VDC) without the addition of an additional power box (28V to 260V converter), which also simplifies the installation on an aircraft and reduces a weight of the E-brake system.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 10%, within 5%, within 1%, within 0.1%, or within 0.01% of a stated value. Additionally, the terms “substantially,” “about,” or “approximately” as used herein represent an amount close to the stated amount that still performs a desired function or achieves a desired result. For example, the term “substantially,” “about,” or “approximately” may refer to an amount that is within 10% of, within 5% of, within 1% of, within 0.1% of, and within 0.01% of a stated amount or value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A method for controlling brake assemblies of a vehicle, the method comprising:
responsive to identifying that only battery backup power is available in the vehicle, modifying, by a brake control unit (BCU), one or more parameters of a set of parameters for locked wheel protection for a set of wheels on the vehicle to adjust for utilizing the battery backup power; and
responsive to detecting a locked wheel event, applying, by the BCU, the locked wheel protection to a brake assembly of a wheel of the vehicle utilizing the modified one or more parameters of the set of parameters.

2. The method of claim 1, wherein the set of parameters includes increasing a gear speed threshold, decrease a time to confirm the locked wheel event, and decreasing a threshold to re-apply braking.

3. The method of claim 2, wherein the gear speed threshold is increased to between 50% and 80%.

4. The method of claim 2, wherein the time to confirm the locked wheel event is decreased to between 50 ms and 150 ms.

5. The method of claim 2, wherein the threshold to re-apply braking is decreased to between 60% and 40%.

6. The method of claim 1, further comprising:
disabling, by the BCU, an antiskid feature for the vehicle.

7. The method of claim 1, wherein identifying that only the battery backup power is available in the vehicle is performed in response to the BCU receiving a brake command.

8. The method of claim 1, wherein the locked wheel event is indicated by a wheel speed transducer indicating the wheel is rotating less than a percentage of a gear speed for about a predetermined time period.

9. A braking system for controlling brake assemblies of a vehicle, the braking system comprising:
a brake control unit, wherein the brake control unit is configured to:
responsive to identifying that only battery backup power is available in the vehicle, modify one or more parameters of a set of parameters for locked wheel protection for a set of wheels on the vehicle to adjust for utilizing the battery backup power; and
responsive to detecting a locked wheel event, apply the locked wheel protection to a brake assembly of a wheel in the set of wheels on the vehicle utilizing the modified one or more parameters of the set of parameters.

10. The braking system of claim 9, wherein the set of parameters includes increasing a gear speed threshold, decrease a time to confirm the locked wheel event, and decreasing a threshold to re-apply braking.

11. The braking system of claim 10, wherein the gear speed threshold is increased to between 50% and 80%.

12. The braking system of claim 10, wherein the time to confirm the locked wheel event is decreased to between 50 ms and 150 ms.

13. The braking system of claim 10, wherein the threshold to re-apply braking is decreased to between 60% and 40%.

14. The braking system of claim 9, wherein the brake control unit is further configured to:
disable an antiskid feature for the vehicle.

15. An aircraft, the aircraft comprising:
a wheel;
a brake assembly associated with the wheel; and
a brake control unit, wherein the brake control unit is configured to:
responsive to identifying that only battery backup power is available in the aircraft, modify one or more parameters of a set of parameters for locked wheel protection for a set of wheels on the aircraft to adjust for utilizing the battery backup power; and
responsive to detecting a locked wheel event, apply the locked wheel protection to the brake assembly associated with the wheel on the aircraft utilizing the modified one or more parameters of the set of parameters.

16. The aircraft of claim 15, wherein the set of parameters includes increasing a gear speed threshold, decrease a time to confirm the locked wheel event, and decreasing a threshold to re-apply braking.

17. The aircraft of claim 16, wherein the gear speed threshold is increased to between 50% and 80%.

18. The aircraft of claim 16, wherein the time to confirm the locked wheel event is decreased to between 50 ms and 150 ms.

19. The aircraft of claim 16, wherein the threshold to re-apply braking is decreased to between 60% and 40%.

20. The aircraft of claim 15, wherein the brake control unit is further configured to:
disable an antiskid feature for the aircraft.
